(19) United States
(12) Patent Application Publication
(10) Pub. No.: US 2006/0049257 A1
(43) Pub. Date: Mar. 9, 2006

(54) Self-aligning contacts for material transport

(75) Inventor: Michael Reiter, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: 4ACCESS COMMUNICATIONS

(21) Appl. No.: 11/199,685

(22) Filed: Aug. 9, 2005

Related U.S. Application Data
(60) Provisional application No. 60/600,118, filed on Aug. 9, 2004.

(51) Int. Cl. G06K 7/08; G06K 7/10

(52) U.S. Cl. 235/449; 235/454

(57) ABSTRACT

A device for advancing thin sheet material such as checks and reading information thereon is disclosed. The device includes first and second paired advancement assemblies for directing the checks through the device. Sensors are positioned between the paired advancement assemblies for magnetically and optically reading information or indicia on the check. Each paired advancement assembly includes a driven roller element driven around respective parallel axes of rotation. The axes are orthogonal to a direction of advancement of the check through the device. Each roller element cooperates with a plurality of balls to engage and advance the check or material located therebetween. The balls are permitted to rotate any direction, and the balls are spring-biased towards the driven roller elements so that the balls may shift towards and away from the driven roller elements, and so that a pressure contact is maintained against the check through the paired advancement assemblies.

### CROSS-REFERENCE TO RELATED APPLICATION(S)

This application claims priority to and benefit of U.S. Provisional Application Ser. No. 60/600,118, filed Aug. 9, 2004, and titled “Self-Aligning Contacts or Media and Material Transport,” the entirety of which is hereby incorporated by reference.

### FIELD OF THE INVENTION

The invention relates to material transport and, in particular, to transport of sheet material through a device for recognizing indicia located on the sheet material.

### BACKGROUND OF THE INVENTION

Conveyance or transport of materials along a particular path, such as through a machine, has long been susceptible to a variety of deficiencies. For instance, it is obvious that materials placed on a rolling-element conveyor will not follow an intended path if the rollers are not properly aligned along that path. Conveyor systems for material such as gravel and mined ore may simply utilize upstanding side walls or other features so any stray material is simply and crudely directed back onto the conveyor. In contrast, a machine vision system that recognizes defects in manufactured components via scanning small portions of the component relies on the portions being in a particular field. As a further example, robotic testing devices used for quality control of minute electronic circuitry require a highly-precise position of the circuitry.

Currently, banking and other institutions that handle and process funds are increasingly turning to automated systems for reducing labor and decreasing processing time of fund transfers. Telephone banking is becoming safer and more sophisticated enabling customers to manage accounts quickly and around-the-clock. On-line banking is being promoted as a teller-less option for transferring funds, as well as for paying bills that would normally be paid by a check. Debit cards are being used by many people to replace the customarily used check or negotiable instrument, and purveyors of goods and services are trading a fee paid to the card-issuing companies in exchange for the assurances of payment, thus avoiding check kiters who are estimated to cost merchants $23 billion dollars per year.

Nonetheless, many people continue to rely on check instruments for making payment. Some people simply find it much more convenient to write a check than make payment in another manner. Many institutions, such as some credit card companies, charge a fee for telephone payment. Many people simply are not comfortable with transmitting banking or financial transactions through the internet. Some retailers refuse credit cards due to a refusal to pay the 2-5% fee required of the major card issuers. Accordingly, banks are also utilizing a variety of systems and procedures for rapidly processing these check instruments.

Most commonly, a check-reading machine is used to recognize indicia located on a face of the check. For the point-of-sale industry, the check-reading machine allows a merchant, for instance, to transmit essentially a facsimile copy of the check to their banking institution. In some forms, the check-reader itself may automatically cancel the check. For an institution receiving large amounts of checks, the check-reader may perform the same service, and then bundle the checks for safekeeping and/or for destruction at a later time.

The transmitted image is typically provided with identifying information including the bank account number and monetary amount. Most pre-printed check instruments are designed to facilitate recognition of the bank account number carried on their face by the card reader. For a typical checking account, this indicia includes an institutional routing number and a number indicating the specific account number, both numbers bracketed by standard default characters.

Principally, one of two methods is employed by the card reader. In one method, the characters may be printed to include ferrous material such that they are recognized magnetically by a magnetic reader. For the other method, the card reader utilizes optical recognition of the characters. For either method of indicia recognition, relative movement of the indicia is utilized for reading the characters.

It is in this reading that problems often occur. The check is directed through the reader so that the indicia passes by a sensor for collecting the information. The sensor thus reads the information line-by-line, in essence. If the check does not proceed by the sensor as expected, an erroneous reading may occur. For instance, a thin vertical line passes by the sensor much more quickly than a thick line that is perhaps five times as great a width. However, if a mechanism for advancing the check slips so that the check does not properly advance, the same thin line may be read multiple times and interpreted as being much thicker than it truly is. In addition, if the linearly-oriented numbers are not presented to the sensor in the proper linear orientation, such as by the check being skewed in orientation as it passes the sensor, the numbers become elongated in appearance to the sensor. Accordingly, dark and light portions of the check become elongated, and an incorrect reading may result. In a severe case, the line of numbers may be shifted entirely out of the path of the sensor so that a complete reading is not made of the numbers.

Once read by the sensor, the characters are interpreted by a processor. That is, software is typically utilized that compares the characters read by the sensor to known templates for the characters. If the check is not directed through the manner properly, such as because of slipping between the check and the machine or because of the check passing the sensor in a skewed path, the software may not properly interpret the number. In the best case scenario, the reading is simply rejected and a user is directed to re-feed the check into the machine. In the worst case scenario, the check is mis-interpreted, which can lead to banking errors and significantly more labor to correct, thus defeating the purpose of the card reader.

The most common design for a card reader utilizes vertically-aligned cylindrical rollers for advancing and directing the check through the reader and across the sensor. A driven roller is pair with a dead roller, commonly referred to as a pinch roller pair. An amount of pressure is exerted between the paired driven and dead rollers to pinch the check and direct the movement of the check. In other designs, one or more of the rollers are simply formed with a compressible material, and the rollers are positioned so as not to provide for their natural diameters. In other designs, one of the two rollers is biased, such as by a spring, towards the other roller to create the pressure.

Card readers utilizing paired cylindrical pinch rollers are particularly susceptible to directing a check across a sensor in a mis-aligned manner. To operate properly, the exterior surfaces of the rollers are uniformly cylindrical, and the central axes of the cylinders are aligned in a parallel orientation. Such design criteria are difficult for any two cylinders, particularly when one or more of the rollers is formed with an outer portion that is deformable and is likely hot-formed such as by molding. In addition, due to the relatively small size of the rollers, a measurably slight eccentricity or deviation results in a relative large angular deviation from parallel. Some designs utilize a self-aligning feature by allowing the biased roller to rotate in a second axis. However, such a feature controls normalization of the position of the self-aligning roller by relying on friction or pressure between the rollers. This friction can vary significantly, and rapidly moving parts may behave erratically and unpredictably. Accordingly, these designs also suffer from mis-alignment or mismatch between the rollers.

Common to all paired-roller designs is imperfect rollers. It is not infeasible for manufacturing to produce properly-shaped rollers. However, usage of the rollers often takes properly-shaped rollers and renders them improperly shaped. It should be noted that the rollers have some degree of surface tackiness or grip for drawing the check therebetween. As such, the rollers have wear surfaces. Any improper alignment or eccentricity, particularly at high speed, will cause uneven wear on the surfaces. In addition, the checks directed therebetween may cumulatively result in uneven wear. Thus, the cylindrical roller may have exterior surface portions that are no longer aligned with the axis of rotation, or the roller itself may become conical.

The rollers are typically operated at high speed, regardless of the speed recognized as the linear speed of a single check through the machine. More specifically, the rollers are driven by a stepper motor. This is done so that the precise position of the check can be controlled, and the check can be advanced in the line-by-line manner preferable for the recognition of the indicia thereon. Accordingly, the stepper motor may advance the check by successive small amounts, in the order of fifty times per second. With a finite perspective, it can be seen that the starting friction and near-impulse force to rotate the rollers repeatedly causes variable or uneven wear around the circumferential surface of the roller. Over time, this can create uneven force and/or eccentricity.

These machines are also prone to mis-alignment due to vibration. As the stepper motor pulses at high speed, this creates oscillating forces experienced through the device. Though forced harmonics do not tend to be an issue, the vibration is experienced by each component that moves relative to another component. For instance, the roller that is designed to self-align on a second axis can vibrate or shift due to the vibration in the device caused by the stepper motor. In addition, any slight eccentricity of a rotating component, or varying forces experienced between two components in contact, will cause a vibration. At times, these vibrations can lead to shifting of components relative to each other, which itself can lead to driving the check in an errant direction.

The result of each of these problems with paired rollers is improper operation. Most pointedly, improper operation is one roller driving the check with a lateral movement relative to the desired direction of travel. This driving occurs by non-cylindrical rollers, eccentric rollers, and/or rollers that do not rotate around parallel axes.

Accordingly, there has been a need for improvements in transporting sheet material such as checks, and for improvements in card-readers for reading indicia on the sheet material.

### SUMMARY OF THE INVENTION

In accordance with one aspect of the present invention, a device for receiving, advancing, and reading information on checks or other thin material is disclosed. The device includes one and preferably two paired advancement assemblies for gripping and directing the checks through the device. Preferably, the device includes sensors for magnetic and/or optical reading of information or indicia on the check, and preferably the sensors are positioned between first and second paired advancement assemblies.

Preferably, each paired advancement assembly includes a roller element driven by a drive train. The roller elements have an axis of rotation, and each axis of the roller elements is parallel to each other and orthogonal to a direction of advancement of the check through the device. Each roller element cooperates with and engages a biased spherical roller element or ball, or engages a check or other material located therebetween. The spherical roller elements are free to rotate in any direction and are, thus, self-aligning contacts for advancing the thin sheet material such as the check. The spherical roller elements are retained within a spherical roller assembly to allow the rotation, and to allow shifting towards and away from the driven roller elements. The bias of the spherical roller elements maintains a pressure contact by the spherical roller elements and the driven roller elements against the check.

### BRIEF DESCRIPTION OF THE DRAWINGS

In the drawings, FIG. 1 is a perspective view of a check being received by a check reading device with a housing partially cut away to show a portion of internal components including paired advancement assemblies for advancing the check into a housing slot and through the check reading device, the paired advancement assemblies including a driven roller and spherical roller elements spring-biased towards the driven roller;

FIG. 2 is a top plan view of the internal components having a frame plate and a biased plate opposing the frame plate, the plates defining a frame slot for receiving the check therethrough and corresponding to the housing slot;

FIG. 3 is a first perspective view of the internal components of FIG. 2 including a pair of spherical element assemblies of the paired advancement assemblies;

FIG. 4 is a second perspective view of the internal components of FIG. 2 showing a control board for communication with electronic components of the check reading device;

FIG. 5 is a perspective view of an optical sensor, a magnetic sensor, and a drive train for providing rotational power to the paired advancement assemblies and to pinch roller assemblies;

FIG. 6 is a top plan view of a portion of the drive train, the paired advancement assemblies, the pinch roller assemblies, and the sensors;

FIG. 7 is a perspective view of the paired advancement assemblies including the driven roller, showing a spherical element assembly with a partially cut away assembly plate, the spherical element assembly having springs for biasing pistons and the spherical roller elements towards the driven roller, and showing a partially cut away retainer plate for positioning the spherical roller elements;

FIG. 8 is a perspective view of the assembly plate of FIG. 7;

FIG. 9 is a front side elevation view of the assembly plate of FIG. 7;

FIG. 10 is a perspective view of the piston of FIG. 7;

FIG. 11 is a perspective view of the internal components of FIG. 2 with the biased plate removed to show a track of the frame slot; and

FIG. 12 is a side elevation view of the paired advancement assemblies and sensors.

### DESCRIPTION OF THE PREFERRED EMBODIMENTS

Referring initially to FIG. 1, an apparatus, referred herein as a reader 10, for collecting information from the face of a thin material such as a check 12, for processing the information, and for communicating or displaying the information is illustrated. The reader 10 includes a housing 14 for mounting internal operational components 16, supporting a key pad 18 or other operator controls, a display screen 20, and a paper roll (not shown) for printing receipts, reports, or the like from a paper slot 22. The reader 10 may also be equipped with a slot (not shown) into which a credit card, debit card, or the like may be slid for reading.

As can be seen, the internal components 16 include at least one, and preferably two, paired advancement assemblies 30 for moving the check 12 through a housing slot 32. More specifically, the check 12 may be inserted or placed into the housing slot 32, and the paired advancement assemblies 30 provide pressure and rotational movement to advance the check 12 in a direction of movement. It is noted that the paired advancement assemblies 30 preferably be driven to advance the check in a first entry direction and a second exit direction.

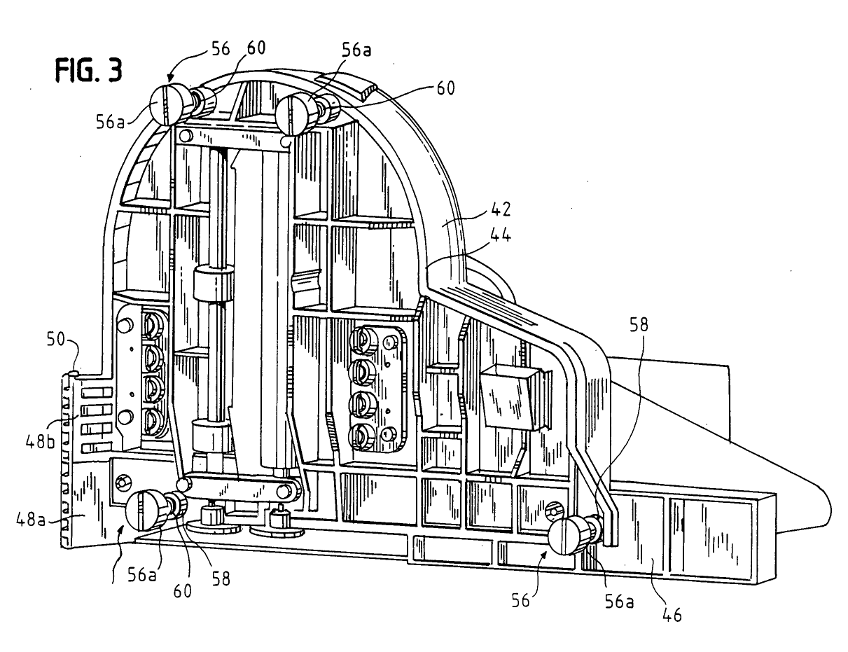

The housing slot 32 is aligned with a frame slot 40 defined by a pair of plates of the internal components 16. The plates include a frame plate 42 and a biased plate 44 positioned a small distance from the frame plate 42 to define the frame slot 40. In the present form, the frame plate 42 is generally fixed or integral with a frame structure 46 for supporting the internal components 16. The frame structure 46 supports the biased plate 44 and, to this end, the frame structure 46 and biased plate 44 include respective hinge knuckles 48a, 48b positioned on a common hinge pin 50, as can be seen in FIG. 3. If necessary to clear debris or a wrinkled check 12 that may become entrapped between the plates 42, 44, the biased plate 44 may be rotated about the hinge pin 50 and away from the frame plate 42. Additionally, this feature permits cleaning of sensors and other components, which will be described below.

The biased plate 44 is secured with and biased towards the frame plate 42 by a plurality of securing pins 56. The securing pins 56 include an enlarged head 56a and a shank 56b passing through bores 58 in the biased plate 44 to secure with the frame plate 42. A bias member such as a spring 60 is positioned around the shank 56b and between the head 56a and the biased plate 44. In this manner, the spring 60 biases the biased plate 44 away from the head 56a and towards the frame plate 42. In the event material, such as the check 12, passing through the frame slot 40 is wrinkled or the otherwise departs from being generally thin, the biased plate 44 is able to move a small amount away from the frame plate 42 so that the check 12 or material does not bind in the frame slot 40.

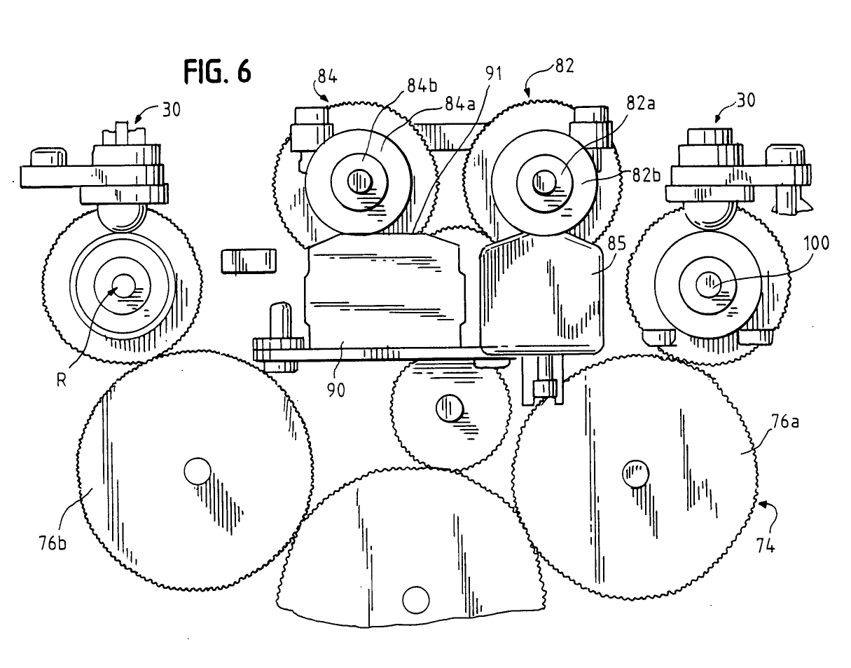

The check 12 is advanced, either in the entry direction or the exit direction, by a drive train 70 supported by the frame structure 46. The drive train 70 includes an electrically driven stepper motor 72 connected to a series of gears 74. The gears 74 include a plurality of drive gears 76 each cooperate with a rotating or driven element. As can be seen in FIG. 6, drive gears 76a and 76b cooperate with a driven roller element 80 of respective paired advancement assemblies 30 for advancing the check 12, as will described below in more detail. Additionally, a drive gear 76c cooperates with first and second rotating pinch roller or bias elements 82 and 84.

The first rotating bias element 82 generally includes a shaft 82a with upper and lower contact cylinders 82b and 82c. The contact cylinders 82b, 82c are preferably formed of soft, resiliently deformable material such as foam. The lower contact cylinder 82c is aligned with and generally presses against a magnetic sensor 85. As a check 12 passes between the first rotating bias element 82 and the magnetic sensor 85, the foam lower contact cylinder 82c is compressed slightly to allow the check 12 to easily pass therebetween. Additionally, the lower contact cylinder 82c presses the check 12 against the magnetic sensor 85. More specifically, the lower contact cylinder 82c and magnetic sensor 85 are positioned in an expected alignment of indicia, such as printed account numbers, on the check 12 that includes ferrous material embedded in the ink forming the indicia. In this manner, the lower contact cylinder 82c presses the indicia against the magnetic sensor 85, thus allowing the magnetic sensor 85 to read magnetically or collect information regarding the indicia.

The first rotating bias element 82 is provided with the upper and lower contact cylinders 82b and 82c so that the rotation is balanced. That is, the resiliently deformable material is selected so that any ability for the contact cylinders 82b, 82c to drive the check 12 off-line is minimized, and the pair serve to balance the on-line driving and somewhat cancel any off-line drive.

It should also be noted that the shaft 82a of the first rotating bias element 82 is in close proximity to the magnetic sensor 85 and the indicia on the check 12 as the magnetic sensor 85 is reading the indicia. In the event the shaft 82a is formed of ferrous material, the reading by the magnetic sensor 85 is impaired. Accordingly, the shaft 82a is preferably a non-ferrous metal and, more preferably, brass. Were a plastic or polymeric material used for the elongated shaft 82a, the tolerances for heat molding are more difficult to control, and the polymeric material is more susceptible to creep and wear. The shaft 82a formed of brass avoids each of these issues.

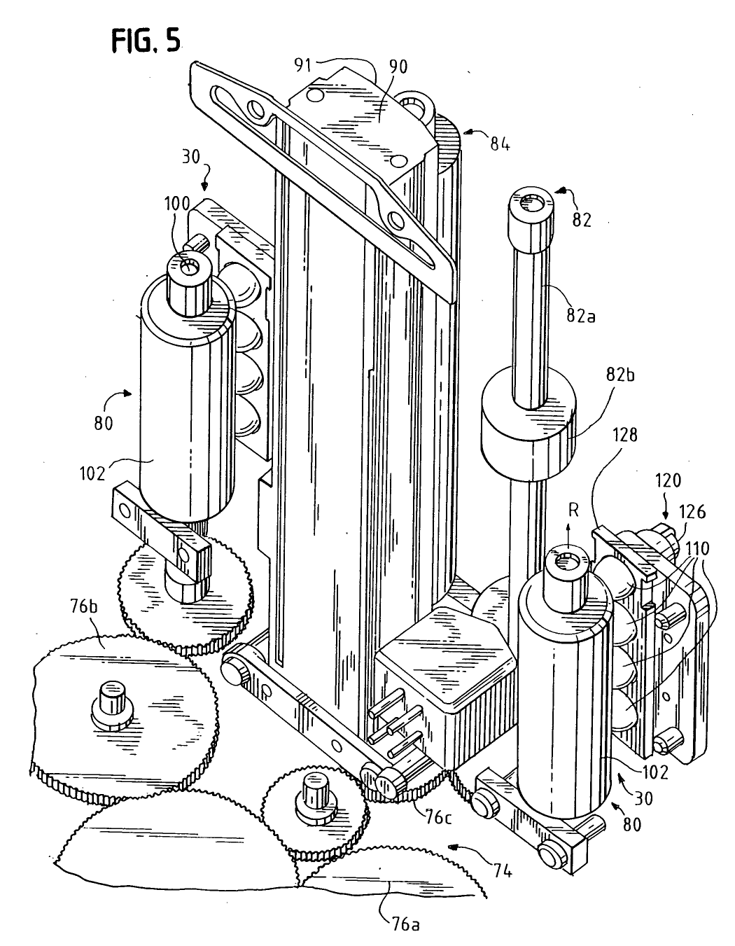

The second rotating bias element 84 assists in optical reading of the check 12 as it passes through the reader 10. The second rotating bias element 84 includes a cylinder 84a of resiliently deformable material such as foam secured around a shaft 84b cooperating with the drive gear 76c. The second rotating bias element 84 presses the check 12 against an optical scanner or sensor 90 for reading and collecting an image of the check 12. As described, the biased plate 44 may be rotated around the hinge pin 60 to permit a glass surface 91 (FIG. 5) of the optical sensor 90 to be cleaned.

As noted above, the check 12 is advanced through the frame slot 42 and through the reader 10 via the paired advancement assemblies 30 including the driven roller elements 80 cooperating with the drive gears 76a and 76b of the drive train 70. The reader 10 includes at least one paired advancement assembly 30, while it is preferred that two assemblies 30 are provided. Each driven roller element 80 includes a shaft 100 cooperating with the drive gears 76a, 76b such that the shaft 100 rotates around an axis R. The axes R of the roller elements 80 are parallel, generally vertical, and orthogonal to the entry and exit directions of the movement of the check 12 through the reader 10. In this manner, the roller elements 80 drive the check 12 in an on-line direction with a minimal amount of off-line driving that otherwise may shift the check 12 off-line and away from the advancement direction.

The shaft 100 is surrounded by a drive cylinder 102 for advancing the check 12. The drive cylinder 102 provides a certain amount of grip or tact for minimizing slippage between the check 12 and the roller element 80. The drive cylinder 102 is preferably a relatively hard yet resiliently deformable material, such as rubber. In this manner, the check 12 is positively gripped and precisely advanced by movement of the drive cylinder 102 while also allowing a certain amount of flexibility in the event the check 12 is wrinkled or otherwise departs from its generally thin thickness or profile.

The paired advancement assemblies 30 include spherical roller elements or balls 110 cooperating with and engaging the drive cylinders 102 for advancing the check 12 therebetween. For a prior art system, the drive cylinders 102 would engage dead rollers having an axis of rotation. Misalignment of the axes of rotation for the drive cylinders 102 and dead rollers results in the above-discussed off-line driving of the check 12, resulting in a reading being improper or failed. The spherical roller elements 110 do not have a defined axis of rotation, instead being free to rotate in any direction around their center. As such, the spherical roller elements 110 are self-aligning with respect to the drive cylinders 102. The balls 110 may be formed of stainless steel, Delrin, or another material suitable for smooth rolling.

The spherical roller elements 110 and drive cylinders 102 have a biased contact and, preferably, an interference contact. As noted, the drive cylinders 102 are somewhat resilient, and this resilience may itself provide the biased contact. Preferably, the spherical roller elements 110 are also biased towards the drive cylinders 102 so that the spherical roller elements 110 may shift toward and away from the axis R of the drive cylinders 102. In this manner, the paired advancement assembly 30 provides a greater dynamic adjustment for incongruities in the material or check 12 passing through the paired advancement assembly 30. In the preferred form, each paired advancement assembly 30 includes four balls 110 vertically aligned and spaced so as to span across a width of a check 12 passing thereagainst.

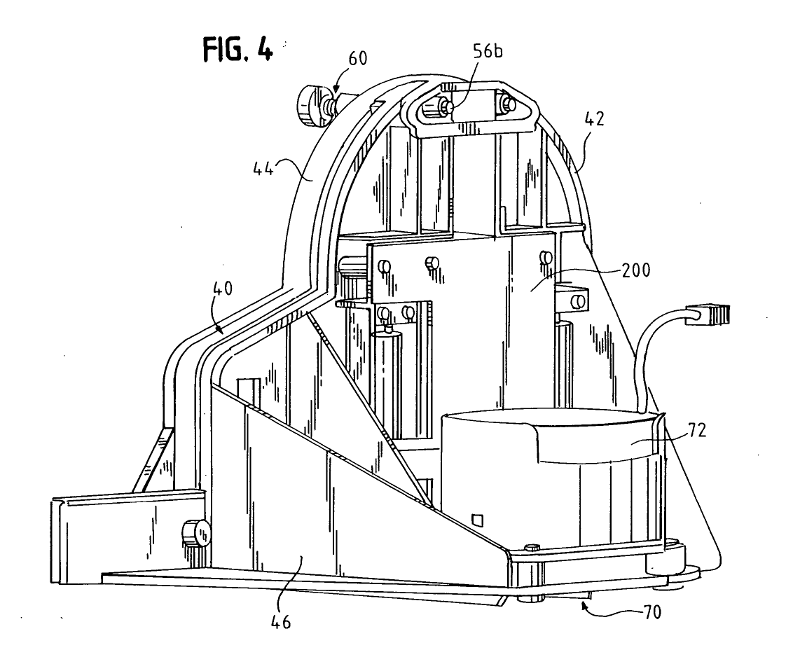

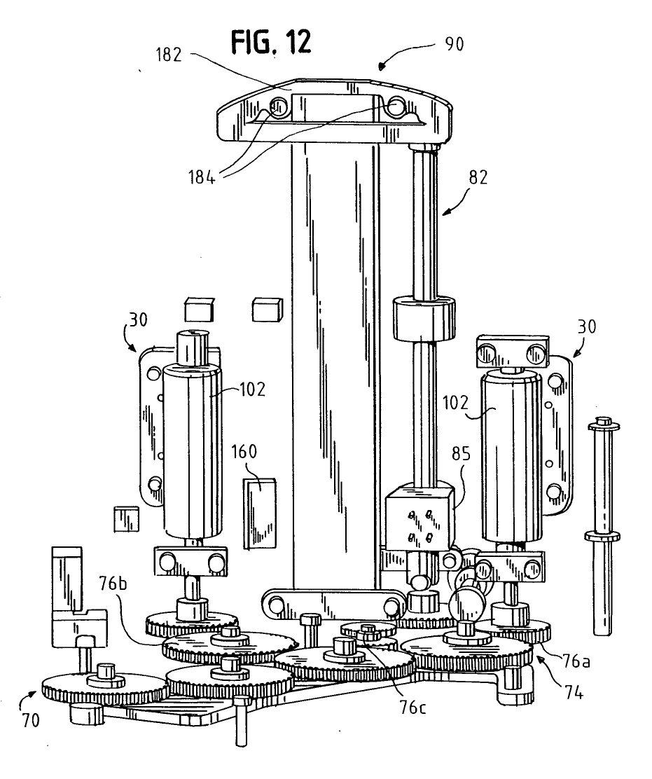

To support and position the spherical roller elements 110, each paired advancement assembly 30 includes a spherical element assembly. The position of the drive cylinders 102 relative to each other and to the frame plate 42 can be seen in FIG. 4, while the position of the spherical element assemblies 120 relative to each other and to the biased plate 44 can be seen in FIG. 3. Furthermore, the positions of the drive cylinders 102 and spherical element assemblies 120 relative to each other can be seen in FIGS. 5, 6, and 12.

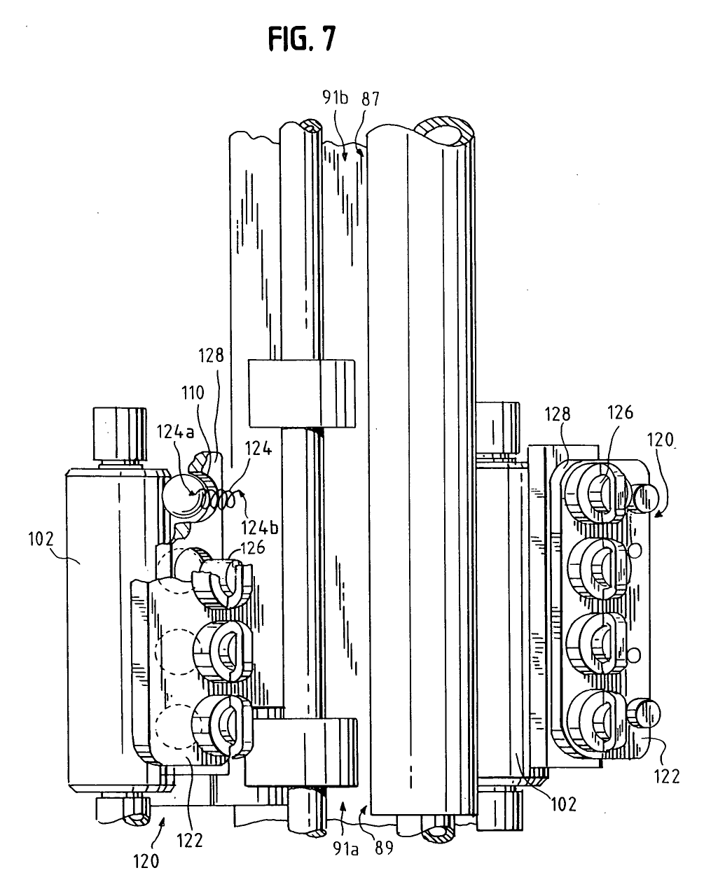

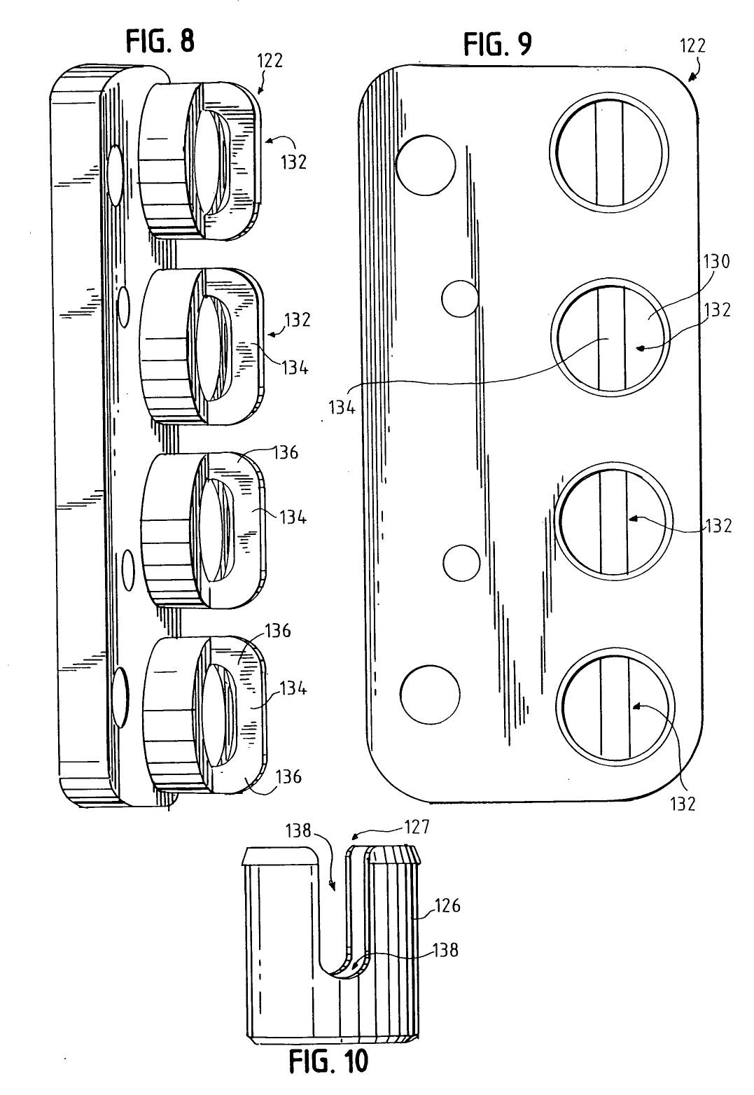

With reference to FIG. 7, the spherical element assembly 120 includes an assembly plate 122, a spring 124 and a piston 126 corresponding to each spherical roller element 110, and a retainer plate 128. The spherical roller elements 110 are positioned within generally circular or partially spherical cavities defined by and within the retainer plate 128. As such, the retainer plate 128 generally limits translation of the spherical roller elements 110, other than rotation or shifting toward and away from the drive cylinders 102. The spring 124 is positioned with a portion within a cavity 127 of the piston 126, and a first spring end 124a presses against an interior surface of the cavity 127 to bias an exterior surface of the piston 126 against a surface on its respective spherical roller element 110, thus biasing the spherical roller element 110 toward and against either the drive cylinder 102 or a check 12 passing therebetween.

The spring 124 has a second end 124b pressed against the assembly plate 122 so that the spring 124 has a pre-load bias force against the piston 126 and, hence, the spherical roller element 110. More specifically, the assembly plate 122 is secured with the retainer plate 128 and, together, the plates 122 and 128 retain the spherical roller elements 110, the springs 124, and the pistons 126 in proper position and in bias-contact with the drive cylinder 102 or check 12.

Towards the end, the assembly plate 122 defines a cavity or throughbore 130 within which portions of the spherical roller elements 110, the springs 124, and the pistons 126 may be located, move, and reciprocate toward and away from the drive cylinder 102. That is, in order for the spherical roller elements 110 to shift away from the drive cylinder 102, the piston 126 abutting the spherical roller element 110 must also shift away. The throughbore 130 is sized to permit the piston 126 to reciprocate therewithin. Additionally, the second end 124b of the spring 124 extends from the piston 126 in a direction away from the drive cylinder 102. The assembly plate 122 includes a spring retainer 132 positioned proximate the throughbore 130 for retaining the spring 124 within the assembly plate 122. The spring retainer 132 is generally a crossbar 134 extending across the throughbore 130 and positioned a distance therefrom by feet 136. The spring second end 124b abuts the crossbar 134 so as to be held in biased position against the piston 126. The piston 126 is provided with channels 138 aligned with the crossbar 134 so that the crossbar 134 may be received within the channels 138. The cooperation between the crossbar 134 and the channels 138 assists in maintaining alignment of the piston 126 and the spring 124 within the spherical element assembly 120, and in maintaining the pistons 126, the spherical roller elements 110, and the drive cylinders 102 in proper contact.

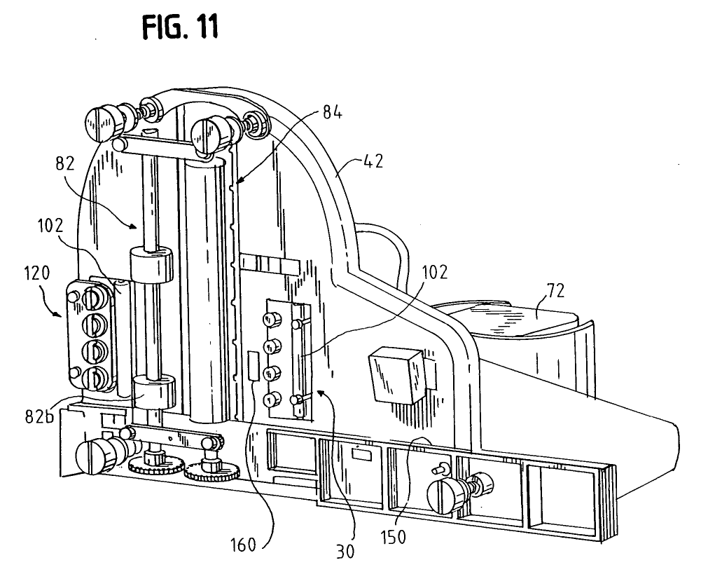

As noted above, the paired advancement assemblies 30 direct material such as the check 12 through the reader 10. The check 12 is typically an elongated piece of thin material and, if an off-line drive is imparted, the check 12 will shift or be skewed as it passes through the magnetic and optical sensors 85, 90, an event which may prevent the check 12 from being read or may cause an erroneous reading. In like manner, the initial insertion and alignment of the check 12 may, if improper, result in the same problems. To assist in the proper insertion, the frame plate 42 includes a guide 150, as can be seen in FIG. 11.

Though the guide 150 may be similarly provided on the biased plate 44, the guide 150 is preferably formed integral with or secured to the frame plate 42. In this manner, the guide 150 extends from the frame plate 42 towards the biased plate 44 so that the guide 150 extends transverse and below the path between the elements of the paired advancement assemblies 30. Accordingly, as a check 12 passes through the paired advancement assemblies 30 and with a lower edge along the guide 150, the advancement of the check 12 is directed by the guide 150. Preferably, the guide 150 does not extend into contact with the biased plate 44 so that the biased plate 44 is permitted to shift towards and away from the frame plate 42, as described above.

In operation, a user initially inserts the check 12 into the housing slot 32 in the entry direction, and finally retrieves the check 12 therefrom in the exit direction. The check 12 is fed into the housing slot 32 and then into the frame slot 40 aligned with the housing slot 32. During this time, the user tactilely recognizes when the check 12 is positioned against the guide 150. For a smooth and flat check 12, the user may simply allow the check 12 to fall of its own accord to the guide 150 within the slots 32, 40, and then manually advance the check 12 a short distance. For checks 12 that are wrinkled or otherwise not particularly flat, the user may lightly pressure the check 12 until the tactile sense of its contact with the guide 150 is felt.

The check 12 is advanced until the drive cylinder 102 of one of the paired advancement assemblies 30 grips the check 12 against the spherical roller elements 110. The check 12 is then advanced by the paired advancement assembly 30, powered by the stepper motor 72, so that a leading edge of the check 12 is advanced towards and in between the second rotating bias element 84 and the optical sensor 90. The optical sensor 90 composes an image of the check 12 by combining a series of optical images taken as the check 12 advances thereacross.

As portions of the check 12 pass from the first paired advancement assembly towards the optical sensor 90, the indicia including the ferrous material, noted above, passes by a magnetizing element 160. The magnetizing element 160 imparts at least a temporary magnetic flux to the indicia so that it can be magnetically read. Alternatively, the magnetizing element 160 may be provided subsequent to the second rotating bias element 84. After the indicia has passed by the magnetizing element 160, the lower contact cylinder 82b of the first rotating bias element 82 presses the advancing check 12 against the magnetic sensor 85.

The check 12 is then advanced by a second paired advancement assembly 30. This allows the check 12 to be advanced a sufficient amount so that the entire length of the check 12 passes by the optical and magnetic sensors 90, 85. Once the check 12 has been advanced a pre-determined distance, selected distance, or dynamically recognized distance, the stepper motor 72 reverses so that the check is advanced in the exit direction.

The operation of the internal components 16 of the reader 10 is directed by a control board 200, illustrated in FIG. 4. More specifically, a signal may be provided to the control board 200 to activate the stepper motor 72, thereby activating the drive gears 76. The control board 200 activates the magnetizing element 160 for imparting magnetic flux to the numeric indicia on the check 12. The control board 200 activates and controls the magnetic sensor 85 and the optical sensor 90, and collects the information received from the magnetic and optical sensors 85, 90. Moreover, the control board 200 interprets and/or transmits the collected information.

As described above, the stepper motor 72 may result in vibration being transmitted through the reader 10. Though tending to have little, if any, effect on the operation of the described operation of the reader 10, the vibration can cause undesirable noise. Accordingly, dampers such as foam pads (not shown) may be located at various points in the internal components 16. For instance, a foam pad may be located outboard of the spherical element assembly 120, between the assembly plate 122 and the biased plate 44.

In the preferred embodiment, there is a downward driving against the check 12. That is, it is preferred that the check 12 remained against and aligned with the guide 150. Towards this end, one or more of the internal components 16 provides a downward push or drive to the check 12 to, in effect, maintain the contact between the check 12 and the guide 150.

In the present form, a downward drive is imparted to the check 12 by the second rotating bias element 84 cooperating with the glass surface 91 of the optical sensor 90. As noted, the second rotating bias element cylinder 84a is resiliently deformable, such as foam. When the reader 10 is assembled, the planar glass surface 91 is set at an interference position with the deformable cylinder 84a. To provide the downward drive, the glass surface 91 is also set at an angle relative to the axis of rotation of the shaft 84b. More specifically, a bottom portion 91a of the glass surface 91 is positioned closer to the shaft 84b than is a top portion 91b (FIG. 7). The cylinder 84a is then compressed locally against the glass surface 91 in a varying amount. In effect, the surface of the cylinder 84a in contact with the glass surface 91 (or with a check 12 therebetween) thus becomes a tapered bearing.

The cylinder 84a provides the downward drive due to this tapered compression. The cylinder 84a, when rotating, has a generally uniform angular rotation around the shaft 84b. However, the compression provides localized variance of the diameter when contacting the glass surface 91. Accordingly, a linear velocity of an upper portion 87 of the cylinder 84a, in contact with the upper portion 91b, is greater than a linear velocity of a lower portion 89 of the cylinder 84b in contact with the lower portion 91a (FIG. 7). This velocity difference results in the downward drive.

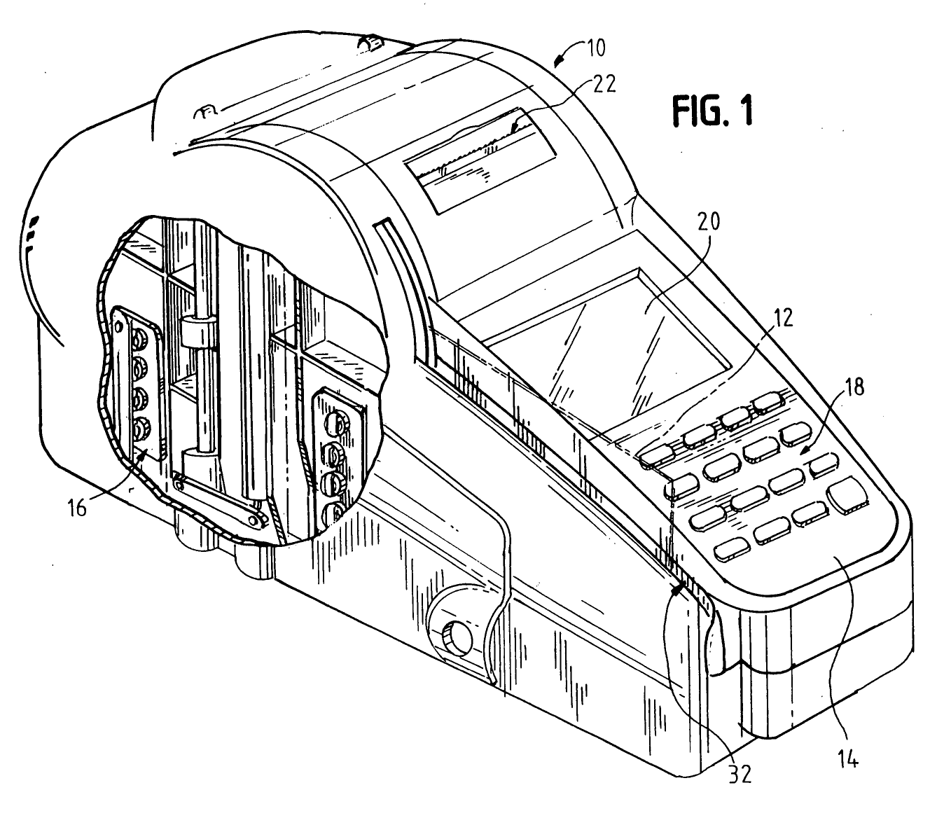

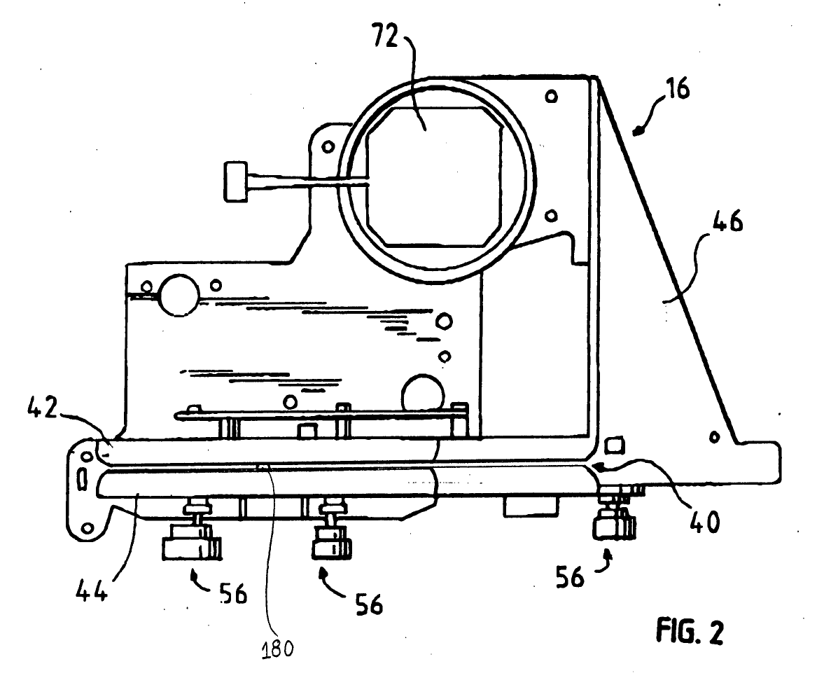

To achieve the angle between the plane of the glass surface 91 and the axis of rotation of the shaft 84b, the optical sensor 90 is set at an angle by a position pin 180 located on the biased plate 44, as can be seen in FIG. 2. When the biased plate 44 is secured with the frame plate 42, the position pin 180 contacts the glass surface 91. The optical sensor 90 is secured at the top by a leaf bracket 182 forming a leaf spring, the leaf bracket 182 itself secured to the frame plate 42 by fasteners 184. As the position pin 180 pushes against the optical sensor 90, the leaf bracket 182 flexes to allow the optical sensor 90 to tilt away from the biased plate 44 and the position pin 180. In the preferred embodiment, the angle from the vertical that the optical sensor 90 is tilted is in the order of 2 degrees, though this may vary depending on the materials used, the size of the components, and on the check 12 itself.

While the invention has been described with respect to specific examples including presently preferred modes of carrying out the invention, those skilled in the art will appreciate that there are numerous variations and permutations of the above described devices and methods that fall within the spirit and scope of the invention as set forth in the appended claims.

What is claimed is:

1. Apparatus for moving thin sheet material, the apparatus comprising:
at least a first paired advancement assembly including:
a cylindrical roller, and
a plurality of balls having a portion biased against the cylindrical roller;
a drive mechanism for driving the cylindrical roller on an axis of rotation; and
a slot for permitting insertion of the sheet into contact with the balls and cylindrical roller, the slot having an alignment surface for guiding an edge of the sheet material while being fed through the slot.

2. The apparatus of claim 1 wherein the apparatus is a reading device for information collection from at least one surface of the sheet material.

3. The apparatus of claim 2 wherein the information collection includes optical collection.

4. The apparatus of claim 2 wherein the information collection includes magnetic collection.

5. The apparatus of claim 1 wherein the plurality of balls includes at least four balls positioned generally along a line orthogonal to the alignment surface.

6. The apparatus of claim 1 wherein the axis of rotation is generally orthogonal to a direction of movement by the sheet material through the feed slot.

7. The apparatus of claim 6 wherein the plurality of balls are positioned generally along a line parallel to the axis of rotation of the roller, and the biased portions of the balls are positioned to span a substantial portion of the sheet material in a direction transverse to the direction of movement through the slot.

8. The apparatus of claim 6 wherein the direction of movement is generally parallel to the alignment surface.

9. The apparatus of claim 1 including a first paired advancement assembly and a second paired advancement assembly, and at least one sensor for collecting information.

10. The apparatus of claim 9 wherein the axes of rotation of the roller of each paired advancement assembly are generally parallel, and the paired advancement assemblies are positioned a distance away from each other along the slot.

11. The apparatus of claim 10 wherein the sensors are positioned along the slot for information collection as the sheet material is advanced through the slot, and at least one sensor is positioned between the paired advancement assemblies.

12. An apparatus for collecting data from sheet material, the apparatus comprising:
a housing defining a slot for receiving sheet material therein;
an advancement mechanism for moving the sheet material through the apparatus in a first entry direction of movement and in a second exit direction of movement, the first and second directions being opposite;
the advancement mechanism including first and second paired advancement assemblies, each advancement assembly including a rotationally driven roller, and at least one ball biased generally into an interference with a surface of the roller.

13. The apparatus of claim 12 wherein the balls have at least a portion in contact with the surface of a roller prior to entry of sheet material, and the sheet material is received between the balls and the rollers with an amount of bias pressure.

14. The apparatus of claim 13 wherein the balls are spring biased.

15. The apparatus of 14 wherein each ball is provided with a respective spring.

16. The apparatus of claim 12 wherein the rollers have respective axes of rotation, the axes are generally parallel, and the exit and entry directions of movement are generally orthogonal to the axes of rotation.

17. The apparatus of claim 13 wherein the balls are permitted to freely rotate relative to both axes of rotation.

18. The apparatus of claim 12 wherein the housing includes a first plate and a second plate for defining the slot, wherein at least one plate is biased towards the other plate.

19. An apparatus for collecting data from sheet material, the apparatus comprising:
a slot for receiving the sheet material therein;
first and second plates for guiding sheet material into the slot;
an alignment edge positioned across the and defining one portion of the slot, the alignment edge providing at least an initial direction of movement by sheet material into the apparatus;
a rotationally driven roller for directing the sheet material through the apparatus;
a set of balls positioned so as to contact the roller prior to entry by sheet material into the apparatus and so as to press the sheet material against the roller subsequent to entry into the apparatus.

20. The apparatus of claim 19 wherein the roller includes at least an exterior portion formed of resiliently deformable material, wherein the balls are positioned such that a pressure is applied between the roller and the balls upon receipt of sheet material therebetween.
